(19) United States
(12) Patent Application Publication
(10) Pub. No.: US 2024/0409404 A1
(43) Pub. Date: Dec. 12, 2024

(54) CARBON FORMATION DETECTION IN PROCESS EQUIPMENT

(71) Applicants: Kelly Nicholson, Dracut, MA (US); Monica Zanfir, Williamsville, NY (US); Jerome T. Jankowiak, Willis, TX (US)

(72) Inventors: Kelly Nicholson, Dracut, MA (US); Monica Zanfir, Williamsville, NY (US); Jerome T. Jankowiak, Willis, TX (US)

(21) Appl. No.: 18/737,251

(22) Filed: Jun. 7, 2024

Related U.S. Application Data
(60) Provisional application No. 63/507,609, filed on Jun. 12, 2023.

(51) Int. Cl. C01B 3/38; B01J 8/06; G01N 27/12

(52) U.S. Cl. CPC C01B 3/38; B01J 8/065; B01J 8/067; G01N 27/12; B01J 2208/00035; B01J 2208/00398; B01J 2208/00707; C01B 2203/0233; C01B 2203/085; C01B 2203/1614

(57) ABSTRACT

The present invention relates to a device, using electrical resistance measurements, and a method to detect the undesirable carbon formation due to chemical processing of mixture of higher hydrocarbons subjected to high temperatures in process equipment such as methane steam reformers, heat exchangers, pipes.

### RELATED APPLICATIONS

This application claims the benefit of U.S. Provisional Application Ser. No. 63/507,609, filed on Jun. 12, 2023, which is incorporated herein by reference.

### FIELD OF INVENTION

The present invention relates to a device, using electrical resistance measurements, and a method to detect the undesirable carbon formation due to chemical processing of mixture of higher hydrocarbons subjected to high temperatures in process equipment such as methane steam reformers, heat exchangers, pipes. A particular application is to control the operation of a steam methane reformer based on carbon formation detection to avoid carbon deposition on reforming catalysts.

### BACKGROUND OF THE INVENTION

Steam methane reforming processes are widely used in the industry to make hydrogen and/or carbon monoxide. Typically, in a steam reforming process, a hydrocarbon-containing feed such as natural gas, steam and an optional recycle stream such as carbon dioxide, are fed into catalyst-filled tubes where they undergo a sequence of net endothermic reactions. The catalyst-filled tubes are located in the radiant section of the steam methane reformer. Since the reforming reaction is endothermic, heat is supplied to the tubes to support the reactions by burners firing into this radiant section of the steam methane reformer. Fuel for the burners comes from sources such as purge gas from pressure swing adsorption (PSA) unit and some make-up natural gas. The following reactions take place inside the catalyst packed tubes:

CₙHₘ+nH₂O<=>(n+0.5m)H₂+nCO

CO+H₂O<=>CO₂+H₂

The crude synthesis gas product (i.e., syngas) from the reformer, which contains mainly hydrogen, carbon monoxide, carbon dioxide, and water, is further processed in downstream unit operations. An example of steam methane reformer operation is disclosed in Drnevich et al (U.S. Pat. No. 7,037,485), and incorporated by reference in its entirety.

Chemical processing of streams of hydrocarbons such as steam reforming for hydrogen production, and heating in heat exchanger equipment can lead to undesirable carbon formation due to hydrocarbon cracking and Boudouard carbon formation reaction. Early detection of carbon formation within the unit operations where this can occur enable operational decisions to modify the operating conditions to ensure carbon free operation. This can avoid any reliability issues and ensure good process performance. For instance, in a top-fired steam methane reformers (SMR), the catalyst is prone to carbon formation typically around 20-30% down the length of the fired tube, especially as the catalyst ages (run time>5 years). The propensity to form carbon is a combination of catalyst reforming activity loss, which allows hydrocarbons to travel further down the tube where temperatures are higher before being consumed, and the downward migration of potash from the catalyst at the upper part of the reformer tube, making that catalyst more susceptible to carbon formation. Carbon formation risks local overheating of the tube metallurgy and potential tube failure. However, operating at higher steam to carbon ratios and lower temperatures to avoid carbon formation leads to plant energy inefficiencies and higher operating costs. It is desirable to understand these break points and optimize plant performance.

Another example is the heating and/or preheating of mixtures of hydrocarbons and steam prior to processing in heating coils, heating pipes, in heat exchangers and/or fire heaters. Carbon formation on heat exchange area leads to poor heat transfer, overheating of the metallic walls; therefore, the integrity of the equipment becomes at risk and the heat transfer efficiency becomes poor, impacting the process efficiency and profitability.

Any early and localized (in-situ) detection of carbon formation can help to modify operating conditions to avoid carbon formation, better scheduling of the preventive maintenance tasks, or catalyst replacement.

Conventional experimental methods for measuring carbon formation on a heterogeneous catalysts using sensors and the measurement of electrical impedance are known. For example, Mueller, N.; Moos, R.; Jess, A. (2009) In situ Monitoring of Coke Depositions during Cocking and Regeneration of Solids Catalysts by Electrical Impedance-based Sensors. Chem. Eng. Tech, p 103 and Mueller, N.; Jess, A.; Moos, R. (2010) Direct detection of coke deposits on fixed bed catalysts by electrical sensors. Sensor and Actuators B: Chemical 144 p. 437 both describe that carbon formation and carbon gasification can be correlated to the values of the electrical impedance measured by using simultaneously a gravimetric method to quantify the amount of carbon formation. Moreover, International Patent Publication No. WO2013/002752 A1 to Peng et al. describes a method of operating a catalytic steam-hydrocarbon reformer based on a “carbon formation” criterion. However, none of the related art provide for a device and method to measure and detect carbon formation in process equipment based on a measurement of electrical resistance to dynamically control operating conditions of the process equipment including SMRs. One of the advantages in operating a stream reformer at optimum conditions within the constraints of carbon formation, (e.g., optimum S/C as a function of catalyst age) can be translated in $100 k-$200 k/yr/plant. Reforming catalyst life extension can be translated as $150 k-$200 k per plant. Moreover, avoiding any damage related to heat exchange equipment, has a reliability component, and typically leads to avoiding equipment replacement costs.

It is an object of the invention in the context of an SMR to (a) increase the steam to carbon ratio to suppress the carbon formation; (b) decrease the reformer outlet temperature to slow down carbon formation; (c) modify the inlet composition of the reformer feed by changing the feedstock or the blend of particular feedstock streams to suppress carbon formation; (d) decide on catalyst replacement schedule based on the spread of carbon detection among multiple reformer tubes within the furnace; (e) decide on catalyst life extension if no carbon formation is detected after a certain period of the catalyst on stream. It is a further object of the invention, to detect and measure undesirable carbon formation in heat exchange process equipment such as heat exchangers, pre-heating coils. This can help to adjust the operating conditions such as increase the steam to hydrocarbon ratio if steam is used in the process, decrease the operating temperature, and modify temperature alarms to allow for safe operation.

Other objects and aspects of the present invention will become apparent to one skilled in the art upon review of the specification, drawings and claims appended hereto.

### SUMMARY OF THE INVENTION

This invention pertains to a method and device for dynamic detection of undesirable carbon formation due to the chemical processing of hydrocarbon based reactive gases in process equipment, and specifically steam methane reformers.

In one aspect of the invention, a method for dynamic detection and measurement of carbon deposits in a steam methane reforming tube through a device containing at least two electrodes connected to at least one catalyst pellet within at least one said reformer tube, a constant current power source attached to the electrodes forming an electrical circuit to measure the electrical resistance of the electrical circuit is provided. The method includes:
providing at least two electrodes and connecting said electrodes to at least one catalyst pellet within the at least one reformer tube;
connecting a current power source to said at least two electrodes forming a closed electrical circuit;
detecting and measuring the electrical resistance continuously while a reactive hydrocarbon based stream is passed through the at least one reformer tube;
measuring any decrease in electrical resistivity by at least one order of magnitude ranging from more than 100-1000 times with carbon deposition under the flow of said reactive hydrocarbon based stream; and
adjusting the process parameters to reduce carbon formation. Specifically increasing the steam to carbon by 0.2-0.0.4 absolute value, and/or decreasing the reformer outlet temperature by 10-30° F., and/or lowering the plant rate below 90%

### BRIEF DESCRIPTION OF THE DRAWINGS

The above and other aspects, features, and advantages of the present invention will be more apparent from the following drawings, wherein:

FIG. 1 (A)-(C) is a schematic depiction of steam method reformers tubes utilized to detect and measure the carbon formation on the catalyst within; and

FIG. 2 is a schematic representation of the process equipment utilized to detect and measure carbon formation within.

### DETAILED DESCRIPTION OF THE INVENTION

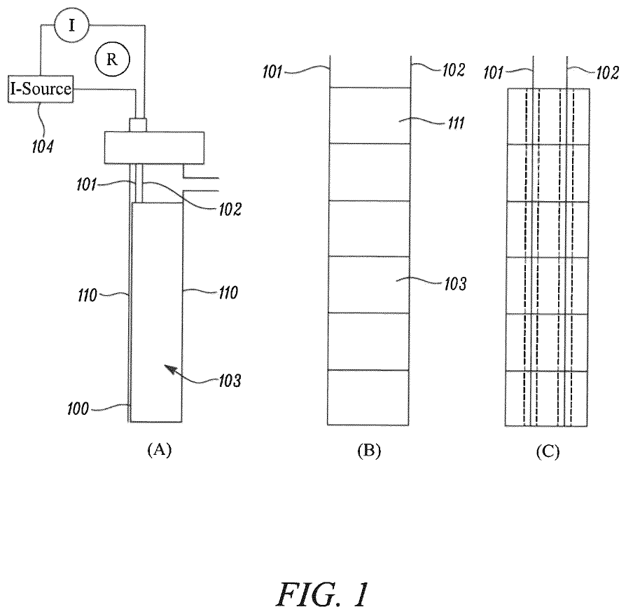

The present invention provides a more effective manner of detecting carbon formation in steam methane reformer tubes, and specifically on reforming catalysts. In one aspect of the invention, and with reference to utilization of a method to determine carbon formation in steam reformer tubes, on reforming catalysts is provided. For instance, in top-fired steam methane reformers (SMR), the catalyst is prone to carbon formation typically around 20-30% down the length of the fired tube, especially as the catalyst ages (e.g., run time>5 years). The propensity to form carbon is a combination of catalyst reforming activity loss, which allows hydrocarbons to travel further down the tube where temperatures are higher before being consumed, and the downward migration of potash from the catalyst at the upper part of the reformer tube, making that catalyst more susceptible to carbon formation. The risks associated with carbon formation include local overheating of the tube metallurgy and potential tube failure. However, operating at higher steam to carbon ratios and lower temperatures to avoid carbon formation leads to plant energy inefficiencies and higher operating costs. Thus, it is desirable to understand these break points and optimize plant performance. An in-situ measurement can be used to detect the onset of carbon formation within a reformer tube. With reference to FIG. 1(A), the measurement consists of two electrodes (101, 102) that are loaded within the catalyst bed 103, near the wall of the reformer tube 100, but without contacting the wall itself 110. A constant current power source 104 is attached to the electrodes to provide a low flow of electrical current, which conducts from one electrode to the other via the flow of current through the catalyst pellets that bridge the gap between the electrodes. Alternatively, and with reference to FIG. 1(b) pellets 111 of catalyst bed 103 can be stacked in an orientation that allows the electrodes (101,102) to either contact a series of pellets on opposite sides of their circumference or as shown in FIG. 1(c) within the holes of the catalyst pellets 111, if holes are present, with any void space in the holes filled with a conductive paste suitable for reforming temperatures. The penetration of the electrode wires (101, 102) into the reformer tube 100 should, at the minimum, be long enough to capture the entirety of the carbon formation zone over the lifetime of the catalyst. This carbon formation zone is predictable a priori using carbon formation models. Alternatively, the carbon formation zone can be set through the inspection of discharged catalyst from the reformer as a function of tube length. After current is introduced, the electrical resistance of the circuit is monitored either continuously, or at some interval, to ensure that it is stable at a condition where carbon is not expected to form, (e.g., early in catalyst life or at a sufficiently high steam to carbon ratio). After this initial period, the resistance is monitored over the life of the catalyst operation. If carbon begins to form in or around the pellets 111 that are in contact with the electrode wires (101,102), a measurable reduction in the electrical resistance of the circuit will be measured, since carbon is more conductive than the pellets themselves. Typically, the reduction in electrical resistivity is in the range of 100-1000 times due to carbon deposit. This early detection of carbon formation allows the plant operation to be adjusted (e.g., raising the steam to carbon ratio) to minimize potential inefficiencies in the process. This also allows plant engineers to avoid premature changeout of active catalyst. For steam reformers that contain a multitude of tubes, potentially hundreds, the selected tubes to install the in-situ carbon detection measurement could be those with the highest tube metal temperatures in the top 40% of the tube. Typically, there is a temperature distribution in the cross section of a furnace in terms of tube wall temperature of each tube with the temperature difference range, among the tubes, being between 60-150° F. depending how well balanced the furnace is. Mapping of temperature distribution in the furnace is well practiced in the industry using pyrometer and IR Camera measurements, which allow to identify the location of the hottest tubes relative to the cross section of the furnace. Often these may be gap tubes, which experience greater exposure to radiating flue gas or tubes in the center of a harp of tubes where burner jet interactions lead to localized higher tube metal temperatures. Typically, the reformer outlet temperature is decreased by 10-30° F. in response to the carbon detected, or the plant rate is lowered below 90% of the plant capacity.

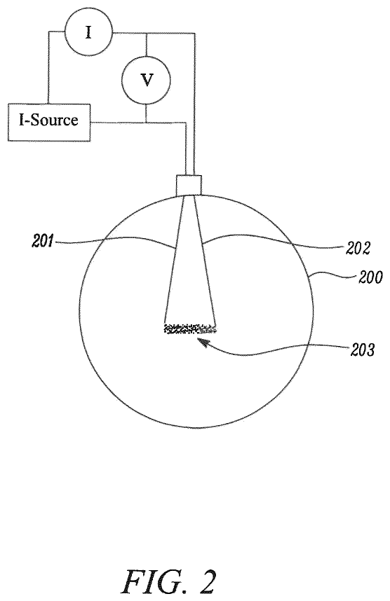

In another exemplary embodiment of the present invention, and with reference to FIG. 2, provides for the determination of carbon formation in processing equipment such as heat exchange equipment and piping. The potential for carbon formation exists whenever heating up gas streams that contain hydrocarbons, especially C₂+ hydrocarbons, and/or carbon monoxide via hydrocarbon cracking and/or Boudouard carbon formation. Carbon formation can create operational issues, such as the fouling of heat exchange piping and downstream equipment that reduces heat transfer performance and the pluggage. The measurement consists of two electrodes (201, 202) that are placed within the process piping 200 within the predominant gas path flow. A constant current power source (210) is attached to the electrodes (201, 202) to provide a low flow of electrical current, which conducts from one electrode to the other via the flow of current through an inert porous ceramic media, such as aluminum oxide 203. In addition to creating continuity in the electrical circuit, the media also serves as a means of capturing carbon dust particles that are entrained in the flowing gas. After current is introduced, the electrical resistance of the circuit is monitored either continuously, or at some interval, to ensure that it is stable at a condition where carbon is not expected to form, (i.e., during startup where the gas flow is typically inert or at a temperature below where carbon would form). After this initial period, the resistance should continue to be monitored. When carbon begins to accumulate on the porous ceramic media, a measurable reduction in the electrical resistance of the circuit will be detected, since carbon is more conductive than ceramic. This will allow modifications to the equipment operation to be made to avoid further carbon formation.

Although various embodiments have been shown and described, the present disclosure is not so limited and will be understood to include all such modifications and variations as would be apparent to one skilled in the art.

We claim:

1. A method for dynamic detection and measurement of carbon deposits in a steam methane reforming tube through a device containing at least two electrodes connected to at least one catalyst pellet within at least one said reformer tube, a constant current power source attached to the electrodes forming an electrical circuit to measure the electrical resistance of the electrical, comprising:
providing at least two electrodes and connecting said electrodes to at least one catalyst pellet within the at least one reformer tube;
connecting a current power source to said at least two electrodes forming a closed electrical circuit;
detecting and measuring the electrical resistance continuously while a reactive hydrocarbon based stream is passed through the at least one reformer tube;
measuring any decrease in electrical resistivity by at least an order of magnitude ranging from 100-1000 times with carbon deposition under the flow of said reactive hydrocarbon based stream; and
adjusting the process parameters to reduce carbon formation.

2. The method of claim 1, wherein at least 10% of the steam methane reforming tubes in a steam methane reformer are fitted with said device for dynamic detection and measurement of carbon formation.

3. The method of claim 2, wherein the steam methane reformer tubes fitted with said device are not adjacent to one another.

4. The method of claim 1, wherein the temperature of the reactive hydrocarbon based stream passed through the at least one reformer tube is higher than 900° F.

5. The method of claim 1, wherein the process parameter modified is the steam to carbon ratio.

6. The method of claim 1, wherein the process parameter modified is the lowering of the plant rate below 90% of design capacity.

7. The method of claim 1, wherein the process parameter modified includes an increase of hydrogen recycle.

8. The method of claim 5, where the steam to carbon ration is increased by about 0.2 to 0.4.

9. The method of claim 1, where a reformer tube outlet temperature is decreased by 10-30° F.
